(19) United States
(12) Patent Application Publication
(10) Pub. No.: US 2005/0202187 A1
(43) Pub. Date: Sep. 15, 2005

(54) Ink jet recording sheet

(75) Inventors: Hirokazu Sunagawa, Tokyo (JP); Satoshi Matsuura, Chiba-shi (JP); Rie Teshima, Tokyo (JP); Kazuo Totani, Tokyo (JP); Hidemasa Kanada, Matsumoto-shi (JP); Masaya Shibatani, Matsumoto-shi (JP); Hiroyuki Onishi, Matsumoto-shi (JP)

Correspondence Address: Ladas & Parry, 26 West 61 Street, New York, NY, 10023, US

(73) Assignees: OJI PAPER CO., LTD.; SEIKO EPSON CORPORATION

(21) Appl. No.: 11/070,852

(22) Filed: Mar. 2, 2005

(30) Foreign Application Priority Data
Mar. 4, 2004 (JP) 2004-061435
Dec. 22, 2004 (JP) 2004-371091

(51) Int. Cl. B41M 5/00

(52) U.S. Cl. 428/32.34

(57) ABSTRACT

Ink jet recording sheet has excellent coloring properties for dye ink as well as pigment ink, a high degree of brightness, and excellent preservability for white paper portions. The ink jet recording sheet includes: a paper supporting medium made by machining pulp; an undercoating layer including at least a pigment and an adhesive; and an ink receiving layer including at least a pigment and an adhesive, the undercoating layer and the ink receiving layer being disposed on at least one surface of the paper supporting medium, and the ink receiving layer being located outermost thereof, wherein the undercoating layer includes titanium dioxide as the pigment and at least one emulsion type adhesive selected from acryl polymers, ethylene-vinyl acetate copolymers, or vinyl acetate polymers; and the ink receiving layer includes silica having an average secondary particle size of 3 to 11 μm as the pigment, and a cationic ink fixing agent.

Priority is claimed on Japanese Patent Application No. 2004-061435, filed Mar. 4, 2004, and Japanese Patent Application No. 2004-371091, filed Dec. 22, 2004, the contents of which are incorporated herein by reference.

### BACKGROUND OF THE INVENTION

1. Field of the Invention

The present invention relates to ink jet recording sheets and to printed matter using the ink jet recording sheets. More specifically, the present invention relates to an ink jet recording sheet which is excellent in ink jet recording properties including coloring property for dye ink as well as pigment ink, the preservability of a white paper portion, and the degree of brightness on the paper surface. Also, the present invention relates to ink jet recording sheet which does not deteriorate the above-mentioned characteristics even when paper material in which pulp recycled from waste paper is used.

2. Description of Related Art

Ink jet recording systems in which aqueous ink is ejected through a nozzle having fine pores to form an image on a recording medium is widely used in terminal printers, facsimiles, plotters, sheet feeding printers, etc., due to low noise during recording, ease of performing color recording, possibility of performing high-speed recording, lower cost than other printing devices, and so forth.

The aqueous ink may be categorized into dye ink which includes dye and pigment ink which includes pigment, and the dye ink is mainly used due to its clearness. However, since the ink jet recording system is often used for large posters displayed outdoors recently, disadvantages of the dye ink have become conspicuous in that it is easily oxidized by ultraviolet rays, ozone, etc., during long-term exhibition to cause discoloration and deterioration in appearance of the image, and a sufficient light resistance of the printed image cannot be obtained.

On the other hand, although the pigment ink has advantageous characteristics that it has excellent light resistance, ozone resistance, and water resistance of the printed image, there is a problem in that a clear printed image cannot be obtained using a conventional ink jet recording sheet for dye ink since the particle size of the pigment ink is significantly larger than that of the dye ink.

For the reasons described above, although both the ink jet recording sheet for dye ink and the ink jet sheet for pigment ink have been developed, demand for an ink jet recording sheet having an excellent coloring property for both dye ink and pigment ink has increased. Also, due to the improvement in the preservability of the printed portion using pigment ink, a coating strength of a printed surface and preservability of a white paper portion (or unprinted portion) are becoming increasingly regarded as important. Since printed matter is formed of printed portions and white paper portions, an ink jet recording sheet which satisfies the above-mentioned coloring properties and possesses excellent preservability in the white paper portion is required.

Also, in addition to the improvement in the printed portion and preservability, it is becoming important to maintain the degree of brightness of ink jet recording sheet or printed matter after being used or kept for a certain period of time under various environments. This is because high degree of brightness of white paper portion and excellent preservability thereof are required, in addition to the above-mentioned coloring property, in order to maintain clearness of printed portions to be recognizable since a printed matter is usually constituted by printed portions and white paper portions.

As a method for obtaining an ink jet recording sheet which exhibits excellent coloring properties using dye ink as well as pigment ink, various methods have been proposed, such as a method in which a water soluble metal salt and vapor phase silica are included in a coating solution (for example, refer to Japanese Unexamined Patent Application, First Publication No. 2002-274022), a method in which two or more layers of ink receiving layer are formed (for example, refer to Japanese Unexamined Patent Application, First Publication No. 2000-168228, Japanese Unexamined Patent Application, First Publication No. 2002-347330, and Japanese Unexamined Patent Application, First Publication No. Hei 10-278411), a method in which the surface of an ink receiving layer is controlled to have a certain roughness (for example, refer to Japanese Unexamined Patent Application, First Publication No. 2000-158804), and a method in which pigments having a specific particle size are contained in an ink receiving layer (for example, refer to Japanese Unexamined Patent Application, First Publication No. 2001-270238).

Recently, demand for paper is increasing, contrary to some predictions, and the availability of pulp which is a raw material for paper is decreasing world wide. On the other hand paper contained in garbage in cities is increasing, and it is necessary to improve recycling of used paper and to increase the rate of using the recycled paper from the viewpoints of global environment and natural resources protection. In the field of ink jet recording paper, also, proposals have been made to include pulp recycled from waste paper in ink jet recording papers (for example, refer to Japanese Unexamined Patent Application, First Publication No. Hei 10-278416, Japanese Unexamined Patent Application, First Publication No. 2003-191616, and Japanese Unexamined Patent Application, First Publication No. Hei 9-142007).

However, the coloring properties of the ink jet recording sheet prepared by the methods described in the former six of the above patent applications are not satisfactory and the preservability of white portions thereof is not improved.

Also, the ink jet recording sheet prepared by the methods described in the latter three of the above patent applications do not satisfy both the preservability of white paper portions and the degree of brightness.

That is, none of the ink jet recording sheets described in the above patent documents satisfy the coloring property for both dye ink and pigment ink, and the preservability of white paper portions. Accordingly, an ink jet recording sheet which has excellent coloring property for both dye ink and pigment ink and satisfies the preservability of white paper portions as well as the degree of brightness has not been obtained. The same naturally applies to ink jet recording paper which utilizes a material in which pulp recycled from waste paper is used.

### SUMMARY OF THE INVENTION

The present invention has been achieved in consideration of the above situation, and an object of the present invention includes to provide an ink jet recording sheet having excellent coloring property for both dye ink and pigment ink, and having excellent preservability for white paper portion and the degree of brightness. In particular, the present invention provides an ink jet recording sheet having an excellent coloring property and the degree of brightness on the paper surface, which is capable of maintaining excellent preservability for white paper portions, even when pulp recycled from waste paper is used as a paper material. Also, the present invention especially provides a mat type ink jet recording sheet having 60° specular gloss of 15% or less with a small coating amount which satisfies the above-mentioned quality level.

That is, the ink jet recording sheet of the present invention includes the following aspects:
(1) Ink jet recording sheet including: a paper supporting medium made by machining pulp; an undercoating layer including at least a pigment and an adhesive; and an ink receiving layer including at least a pigment and an adhesive, the undercoating layer and the ink receiving layer being disposed on at least one surface of the paper supporting medium, and the undercoating layer being sandwiched between the paper supporting medium and the ink receiving layer, wherein the undercoating layer includes titanium dioxide as the pigment and at least one emulsion type adhesive selected from the group consisting of acryl polymers, ethylene-vinyl acetate copolymers, and vinyl acetate polymers as the adhesive; and the ink receiving layer includes silica having an average secondary particle size of 3 to 11 μm as the pigment, and a cationic ink fixing agent.

(2) The ink jet recording sheet according to (1) above, wherein 10% by mass or more of the pulp is recycled pulp obtained from waste paper.

(3) The ink jet recording sheet according to (1) or (2) above, wherein the cationic ink fixing agent includes a dicyandiamide-polyethylene amine copolymer and an acrylamide-diallyl amine copolymer.

(4) The ink jet recording sheet according to (3) above, wherein the cationic ink fixing agent further includes zinc sulfate.

(5) The ink jet recording sheet according to any one of (1) to (4) above, wherein the ink receiving layer includes at least an acryl copolymer as the adhesive.

(6) The ink jet recording sheet according to any one of (1) to (5) above, wherein at least a part of the silica is surface treated silica whose surface is treated by a surfactant.

(7) The ink jet recording sheet according to any one of (1) to (6) above, wherein a 60° specular gloss defined by JIS-Z8741 of a surface of the ink receiving layer is 15% or less.

(8) Printed matter including the ink jet recording sheet according to any one of (1) to (7) above, which is printed using a dye ink.

(9) Printed matter including the ink jet recording sheet according to any one of (1) to (7) above, which is printed using a pigment ink.

According to the present invention, it becomes possible to provide an ink jet recording sheet having an excellent ink jet recording property (coloring property) for both pigment ink and dye ink, which is capable of clearly printing an image with high precision, and has excellent preservability (especially preventing yellowing due to heat) for white paper portions. Also, it becomes possible to provide an ink jet recording sheet which uses waste paper to effectively utilize limited resources yet having a high degree of brightness of the paper surface, an excellent coloring property, and an improved preservability of white paper portions. In particular, according to the present invention, it becomes possible to provide a mat type ink jet recording sheet with small coating amount.

### BRIEF DESCRIPTION OF THE DRAWINGS

Some of the features and advantages of the invention having been described, others will become apparent from the detailed description which follows, and from the accompanying drawing, in which:

FIG. 1 is a diagram showing a schematic cross-sectional view of an ink jet recording sheet according to the present invention.

### DETAILED DESCRIPTION OF THE INVENTION

The invention summarized above and defined by the enumerated claims may be better understood by referring to the following detailed description. This detailed description of particular preferred embodiments, set out below to enable one to build and use particular implementations of the invention, is not intended to limit the enumerated claims, but to serve as particular examples thereof.

Hereinafter, the present invention will be explained in detail.

<Ink Jet Recording Sheet>

(Layer Structure)

The present invention provides an ink jet recording sheet which includes a supporting medium which may be made of pulp; an undercoating layer including, at least, titanium dioxide as pigment, and at least one emulsion type adhesive selected from an acryl copolymer, an ethylene-vinyl acetate copolymer or vinyl acetate copolymer as adhesive; and an ink receiving layer including, at least, silica having an average secondary particle size of 3 to 11 μm, an adhesive, and a cationic ink fixing agent, the undercoating layer and the ink receiving layer are disposed on at least one surface of the supporting medium.

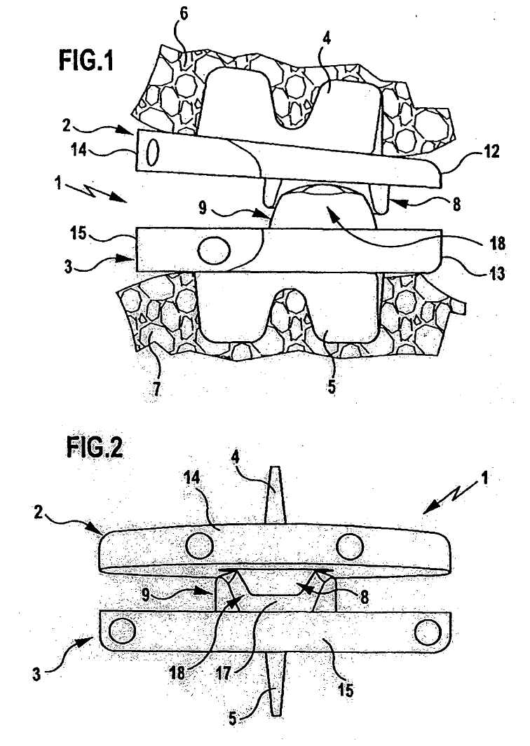

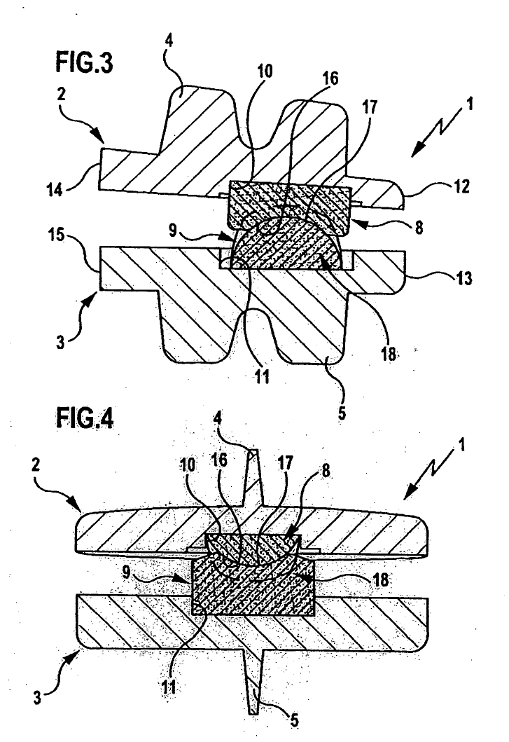

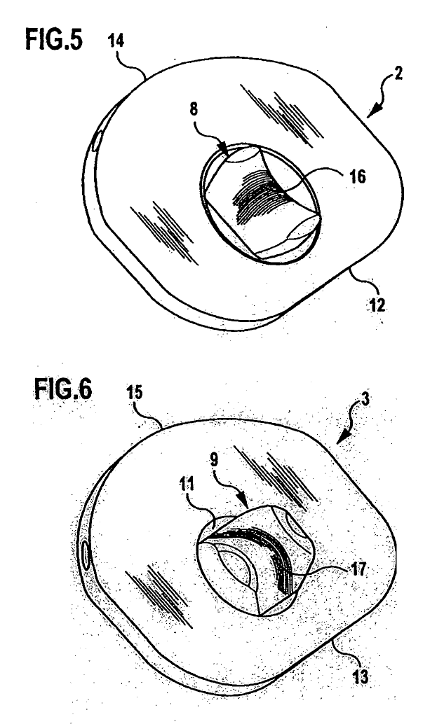

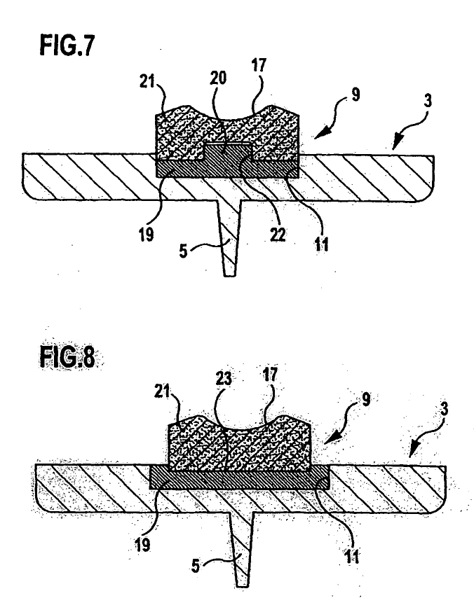

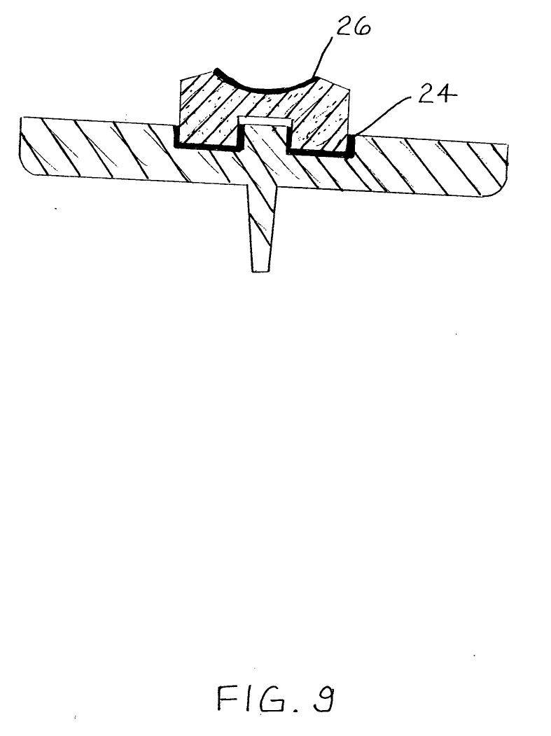

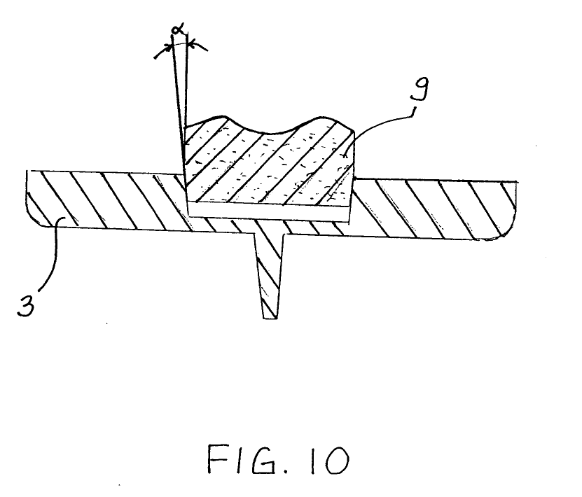

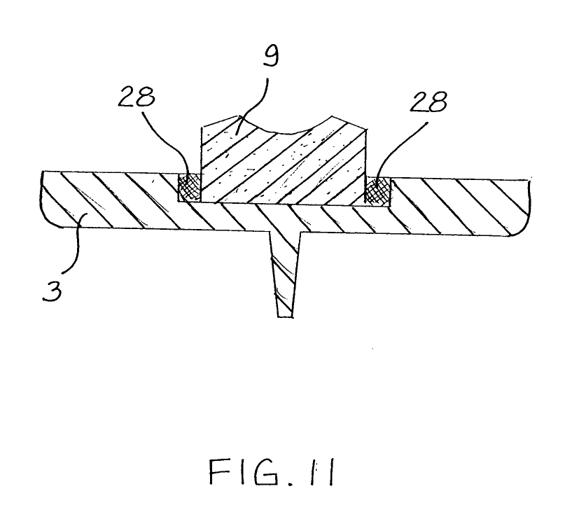

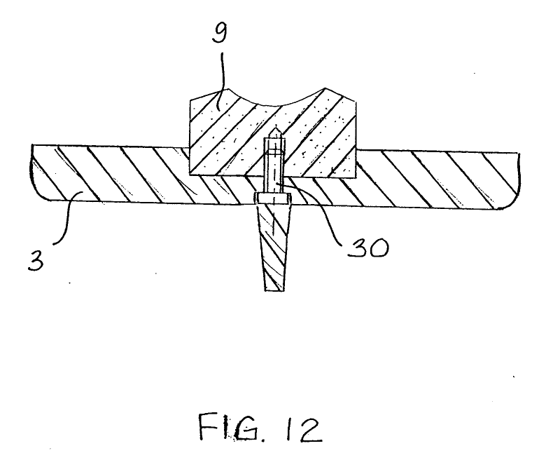

FIG. 1 shows an example of the layer structure of the ink jet recording sheet according to the present invention.

In ink jet recording sheet 10 shown in FIG. 1, an ink receiving layer 16 is disposed on one surface of a paper supporting medium 12 via an undercoating layer 14.

Note that according to the present invention it is possible to provide a similar undercoating layer and ink receiving layer on the other side of the supporting medium. In such a case, it becomes possible to provide a clear print image on both sides of the ink jet recording sheet.

Also, each of the undercoating layer and the ink receiving layer may be formed by a plurality of layers. In such a case the ink receiving layer is located furthermost with respect to the paper supporting medium and the undercoating layer. Moreover, an overcoating layer may be provided on the ink receiving layer in order to give glossiness or to improve the preservability, within a range not deteriorating the recording properties of the ink receiving layer.

(Paper Supporting Medium)

Examples of the pulp which may be used as the main component of the paper supporting medium include: chemical pulp, such as L-bleached kraft pulp (LBKP) and N-bleached kraft pulp (NBKP); mechanical pulp, such as groundwood pulp (GP) and thermomechanical pulp (TMP); and pulp recycled from waste paper. These pulp may be used alone or in a mixture of two or more. Among these, it is preferable to use the LBKP as the main component of the pulp. Also, although the beating degree thereof is not particularly limited, it is preferable to beat until the freeness thereof reaches about 200 to 500 ml (CSF: JIS-P-8121). If the beating degree is too small, cockling when printed tend to occur and uneven absorption of ink tends to be readily caused. If the beating degree is too large, on the other hand, smoothness tends not to be obtained.

Since the ink jet recording sheet according to the present invention includes an undercoating layer which has certain materials, it becomes possible to obtain an ink jet recording sheet having an excellent preservability for white paper portions and a high degree of brightness even when pulp recycled from waste paper or mechanical pulp, which are generally avoided in use for ink jet recording sheets, is utilized for the paper supporting medium.

Waste paper may be used and resources may be effectively utilized by employing 10% by mass or more of pulp recycled from waste paper in 100% by mass of pulp used for machining paper supporting medium. According to the present invention, the degree of brightness and preservability of white paper portion become excellent even when 10 to 100% by mass of pulp is recycled from waste paper.

Examples of the source of waste paper, which is eventually formed as pulp, include newspaper, magazines, paperboard, sealing paper, corrugated fiberboard, and printed matter. Also, broke woodfree paper, coated paper, etc., which may be produced during the production thereof may be included in the waste paper.

Pulp may be generally recycled from waste paper by subjecting waste paper and/or broken paper to, for example, a breaking process using a low concentration or high concentration pulper, a rough selection and well selection process using a screen or cleaner, a deinking process using flotation of water washing method, and a bleaching process using chlorine, chlorine dioxide, sodium hypochlorite, oxygen, etc., with a proper combination thereof.

It is possible to include, other than the above-mentioned pulp, filler in the paper material. The filler may be added to adjust air permeability, to impart opacity, and to adjust ink absorption of the paper material. Examples of the filler include clay, kaolin, sintered kaolin, talc, calcium carbonate, magnesium carbonate, aluminum hydroxide, silica, titanium oxide, zeolite, and so forth. Among these, calcium carbonate is preferable because a paper material having high degree of brightness may be obtained by using it.

It is preferable that 1 to 35 parts by weight of filler be contained with respect to 100 parts of the pulp. If the amount of filler is too small, not only will the level of brightness be lowered but also the absorption of ink tends to be decreased. If the amount of filler is too large, the rigidity and strength of paper tends to be reduced. Note that an addition of too large an amount of calcium carbonate may be a cause of yellowing of ink jet recording sheets.

It is possible to add various additives for machining paper, if necessary, such as conventionally used anionic, nonionic, cationic or amphoteric retention aids, freeness improvers, paper strength improvers, and sizing agents, to a paper material containing the above-mentioned pulp and filler within an amount range which does not deteriorate the effect of the present invention. Also, it is possible to add other additives for machining papers, if necessary, such as a dye, pH adjusting agent, antifoaming agent, pitch controlling agent, and slime controlling agent. However, if too much fluorescent brightening agent is added to the ink jet recording sheet of the present invention, the preservability of white paper portion may be lowered.

A machining method for paper is not particularly limited, and may be performed by using known machining devices, such as a Fourdrinier paper machine, cylinder paper machine, and twin-wire paper machine. Paper produced may be categorized into acidic paper and neutral paper depending on pH of the paper material, and neutral paper may be suitably used as a paper supporting medium according to the present invention from the viewpoint of long-term preservability.

Note that it is possible to apply/impregnate starches, polyvinyl alcohols, cationic resins, etc., onto the surface using a size pressing method, etc., and to adjust the flatness degree of the surface, and improve the strength and the print and writing properties thereof. Also, it is possible to carry out a smoothing process using a calender, etc., in order to improve the smoothness of the paper supporting medium. Note that although the basis weight of the paper supporting medium is not particularly limited, it is generally about 20 to 400 g/m².

(Undercoating Layer)

According to the present invention, the undercoating layer includes titanium dioxide as pigment, and at least one emulsion type adhesive selected from acryl type polymer, ethylene-vinyl acetate copolymer and vinyl acetate polymer as adhesive.

Titanium dioxide may be categorized into rutile type and anatase type depending on the differences of the structure. Although a higher degree of brightness is generally obtained from the rutile type, both may be effectively used according to the present invention. The secondary particle size of titanium dioxide is preferably 0.1 μm to 2 μm, and more preferably 0.3 μm to 1 μm. If the particle size is too small, strength, ink absorptivity and coloring property tend to be decreased. If the particle size is too large, on the other hand, clearness of image tends to be decreased and a smooth and uniform surface may not be obtained.

According to the present invention, excellent preservability of white paper portion, high degree of brightness, and high print concentration may be obtained by forming an undercoating layer which includes titanium dioxide and a specific adhesive. The reasons why such effects can be obtained according to the present invention may be considered as follows.

That is, although silica is known as pigment which may be used for an ink jet recording paper, the permeability of silica for light, water, and gas is high as compared with other pigments. Accordingly, if an ink receiving layer is directly formed on a paper supporting medium which is formed by using pulp recycled from waste paper, the degree of brightness of such paper becomes low and a clear image cannot be printed due to the low degree of brightness. Even if an undercoating layer which includes silica as its main constituent is formed between a paper supporting medium and an ink receiving layer, a sufficient degree of brightness cannot be obtained.

Also, if calcium carbonate is included in the undercoating layer or a large amount of fluorescent brightener is included in order to increase the degree of brightness of an ink jet recording sheet, the preservability of the white paper portion may be lowered. The reason for this may be considered that the cationic ink fixing agent included in the ink receiving layer is oxidized because calcium carbonate and the fluorescent brightener, which is a stilbene derivative, are alkali compounds, and this oxidation enhances the yellowing on the surface of the ink jet recording sheet.

Contrary to this, since the photo diffusion property of titanium dioxide is high and it does not cause oxidation of a cationic ink fixing agent, the degree of brightness and the preservability of white paper portion of an ink jet recording sheet are considered to be improved by forming an undercoating layer using titanium dioxide as pigment.

According to the present invention, titanium dioxide is combined with at least one emulsion type adhesive selected from an acryl polymer, ethylene-vinyl acetate copolymer, or vinyl acetate as adhesive and used.

An ink jet recording sheet having a high degree of brightness and whose preservability of white paper portion tends not to be lowered as explained above may be obtained by using titanium dioxide as pigment in comparison with a case where other pigments, such as kaolin, precipitated calcium carbonate and talc, are used. Also, the amount of a binder (amount of adhesive) may be reduced by using titanium dioxide in combination with the above-mentioned adhesive(s). The ink absorptivity of the undercoating layer (mainly absorptivity of solvent of ink) may increase by decreasing the amount of binder in the undercoating layer, and it becomes possible to print clear images with high fineness on the obtained ink jet recording sheet. Also, the decreasing of amount of binder may contribute to the improvement of the degree of brightness.

Examples of the acryl polymer used in the emulsion type adhesive for the undercoating layer include polymers which have acrylic units, such as acrylic acid, methacrylic acid, acrylate and methacrylate. The acryl polymer may be a homopolymer including (meth)acryl unit, copolymer, or copolymer including other structural units. Examples of the acryl polymer include polymethyl (meth)acrylate.

Examples of the ethylene-vinyl acetate copolymer include copolymers which include ethylene and vinyl acetate as main constituents and other polymers, for example, (meth)acrylate, such as 2-ethylhexyl acrylate, vinyl fatty acid other than vinyl acetate like vinyl barsetate, and monomers which include a functional group like acrylic acid.

Examples of the vinyl acetate polymer include one which has a vinyl acetate unit and polyvinyl acetate is preferable.

Although adhesives other than the above-mentioned emulsion type adhesives or water soluble adhesives are generally known, a sufficient coloring property cannot be obtained if a conjugated diene type resin, such as a styrene-butadiene resin and methyl methacrylate-butadiene copolymer, is used for the undercoating layer, and yellowing of white paper portion occurs as time elapses. Also, for the case where water soluble adhesive, such as starch and polyvinyl alcohol, is used, the concentration of coating solution cannot be increased during the preparation of undercoating layer solution. Accordingly, the coating amount is reduced and targeted degree of brightness, the preservability of white paper portion, and print concentration may not be achieved.

According to the present invention, since titanium dioxide and at least one emulsion type adhesive selected from acryl polymers, ethylene-vinyl acetate copolymers, or vinyl acetate polymers, it becomes possible to obtain an ink jet recording sheet having a high degree of brightness, excellent preservability for white paper portions, and high print concentration. Note that the ratio of the amount of each of the above components is preferably 2 to 30 parts by weight, more preferably 5 to 20 parts by weight, of adhesive with respect to 100 parts by weight of titanium dioxide. If the amount of adhesive is too small, the strength of the undercoating layer will be reduced, and if the amount of adhesive is too large, ink absorptivity, coloring property, and the degree of brightness will be deteriorated.

Note that it is possible to add inorganic pigments to the undercoating layer as long as the pigments do note deteriorate the effect of the present invention. Examples of the inorganic pigment include silica, calcium carbonate, kaolin, talc, calcium sulfate, barium sulfate, zinc oxide, zinc sulfide, zinc carbonate, satin white, aluminum silicate, diatomaceous earth, calcium silicate, magnesium silicate, aluminum hydroxide, alumina, pseudoboehmite, lithopone, zeolite, hydrated halloysite, magnesium carbonate, and magnesium hydroxide.

When these inorganic pigments are added, it is preferable that the amount thereof be adjusted to be 70% by mass or greater with respect to the total of 100% by mass of the inorganic pigments and titanium dioxide.

Also, it is possible to add conventionally known adhesives in the field of ink jet recording sheet to the undercoating layer as long as the adhesives do not deteriorate the effect of the present invention. Examples of the adhesive include: proteins, such as casein, soy bean protein and synthesized protein; various starches, such as ordinary starch and oxidized starch; polyvinyl alcohols and derivatives thereof; cellulose derivatives, such as carboxymethyl cellulose and methyl cellulose; and conjugated diene type resins, such as a styrene-butadiene resin and methyl methacrylate-butadiene resin.

Moreover, it is possible to add various auxiliary agents, which are generally used for producing coated paper, in a suitable amount, to the undercoating layer, such as a thickener, an antifoamer, a wetting agent, a coloring agent, a fluorescent brightener, a fluorescent pigment, an antistatic agent, a light resistance auxiliary agent, an UV absorber, an antioxidizing agent, and an antiseptic agent.

The undercoating layer may be formed by applying an undercoating layer coating solution which includes the above-mentioned pigment, adhesive, and inorganic pigment, etc., if necessary, onto the surface of a paper supporting medium, and drying the coating solution. The coating amount, in terms of solid components, of the undercoating layer is above 3 to 20 g/m², preferably 5 to 15 g/m², and more preferably 7 to 13 g/m². If the coating amount is too small, a high degree of brightness cannot be obtained and the yellowing phenomenon tends to be easily generated. If the coating amount is too large, on the other hand, not only is the effect of the present invention saturated, but also the strength between the layers will be weakened.

The undercoating layer may be formed by using various known application devices, such as a blade coater, an air knife coater, a roll coater, a bar coater, a gravure coater, a rod blade coater, a lip coater, a curtain coater, and a die coater. It is possible, after the coating process, to carry out a finishing process using a calender device, such as a machine calender, a TG calender, a super calender, and a soft calender.

(Ink Receiving Layer)

The ink receiving layer at least includes silica having an average secondary particle size of 3 to 11 μm, an adhesive, and a cationic ink fixing agent.

As for the above-mentioned silica, use of amorphous silica is preferable. Methods for producing the silica are not particularly limited, and it may be produced by using an arc method, a dry method, a wet method (precipitation method, gel method), and so forth. Among these methods, the wet method is preferable since the silica produced by the wet method is suitable for the ink jet recording sheet for pigment ink as well as the ink jet recording sheet for dye ink.

It is preferable that the average particle size of the secondary particle of silica be 3 to 11 μm, and it is more preferable that the average particle size of the secondary particle of silica be 4 to 10 μm. If the average particle size is less than 3 μm, the absorptivity for dye ink of the ink jet recording sheet which includes such silica tends to be reduced. Also, since the light transmittance thereof will increase, the light resistance of an image formed by dye ink as well as the coating strength tends to be reduced. Moreover, when this is used for ink jet recording sheet for pigment ink, disadvantages such as lowering in the fixation property of the pigment ink will occur.

If the average particle size of the secondary particle of the silica exceeds 11 μm, on the other hand, problems tend to occur for the ink jet recording sheet for dye ink as well as for the ink jet recording sheet for pigment ink, such as lowering in clearness of image due to low print concentration and the generation of blurring of image due to surface roughness.

Note that the “average secondary particle size of silica” in this application is measured by using a call counter method, and it indicates a volume average particle size measured by using a sample of silica which is ultrasonically dispersed in distilled water for 30 seconds.

Also, the oil absorption of silica based on JIS K-5101 is preferably 210 to 250 cm³/100 g since such silica has excellent coloring property when recorded using dye ink as well as pigment ink.

According to the present invention, it is preferable that the surface of at least a part of silica contained in the ink receiving layer be treated with a surfactant (hereinafter also referred to as surface treated silica). That is, the surface of all of the silica may be treated with a surfactant, or it is possible to use the surface treated silica with untreated silica. The untreated silica is the same as those explained above, and hence the explanation thereof will be omitted.

(Silica whose Surface is Treated with Surfactant)

As silica whose surface is treated with a surfactant, those which have been explained above may be utilized.

Examples of a surfactant which may be used for treating the surface of silica include nonionic surfactant, cationic surfactant, anionic surfactant, amphoteric surfactant, and so forth. Among these, it is preferable to use nonionic surfactant. Examples of the nonionic surfactant include polyoxyethylenealkyl ether, polyoxyethylenepolyoxypropylene copolymer, and polyoxyethylenepolyoxypropylenealkyl ether. Among these, one having a hydrophile-lipophile balance (HLB) value of 8.0 to 15.0 is preferable, and one having HLB value of 10.0 to 12.0 is more preferable. If the HLB value is less than 8.0, a sufficient ink absorbing rate is difficult to obtain, and if the HLB value exceeds 15.0, on the other hand, feathering tends to be readily generated.

As a method for treating the surface of silica using a surfactant, one which is described in, for example, Japanese Unexamined Patent Application, First Publication No. Hei 9-25440 may be adopted. That is, a dry mixing method may be adopted in which silica, for example, wet type silica, and a surfactant, for example, polychain type nonionic surfactant, are mixed using a mixer, such as a high-speed stream mixer. In such a case, it is possible to add a surfactant directly to silica, and it is also possible to add a surfactant which is diluted with a volatile solvent, such as ethanol, to silica and to mix them.

Moreover, it is possible to adopt a wet treatment method in which a predetermined amount of a surfactant, for example, a nonionic surfactant is added and mixed with an emulsion slurry solution of silica, for example, wet type silica, and a spray-drying process is subsequently carried out. In the wet treatment method, if the surfactant is insoluble with water, it is preferable to strongly disperse the surfactant in water to form an emulsion in advance, sequentially add the emulsion to an emulsified slurry solution of pigment to be sufficiently mixed, and then carry out a drying process.

The surface of the silica which is treated by a surfactant using the method described above is considered to be covered by the surfactant.

The amount of surfactant added is preferably 0.1 to 30 parts, more preferably 0.5 to 20 parts, with respect to 100 parts of silica. When silica which is covered by the surfactant within the above-mentioned range is included, it becomes possible to improve the coloring property and to obtain a clear image.

(Adhesive)

Adhesives used in the ink receiving layer are not particularly limited, and examples thereof include conventionally known adhesives generally used for ink jet recording, such as water soluble adhesives like starch and polyvinyl alcohol, acryl polymers, ethylene-vinyl acetate copolymers, vinyl acetate polymers, urethane type polymers, styrene-butadiene copolymers, and emulsion type adhesives thereof. These adhesives may be used alone or in a mixture of two or more.

Among these, use of an emulsion type adhesive of acryl polymer is preferable. Examples of the acryl polymer include polymers which include acryl unit, such as acrylic acid, methacrylic acid, acrylate and methacrylate. The acryl polymer may be a homopolymer of (meth)acrylic unit or may be a copolymer which may include other structural unit(s). Examples of the acryl polymer include polymethyl(meth)acrylate.

Also, it is preferable to use polyvinyl alcohol together with the emulsion type adhesive of acryl polymer since the adhesiveness with a pigment will become excellent in this manner.

As the polyvinyl alcohol, derivatives of polyvinyl alcohol, such as silanol denatured polyvinyl alcohol and cationized polyvinyl alcohol, may also be suitably used.

Note that for the case where the acryl polymer is used together with polyvinyl alcohol or derivatives thereof, the ratio thereof is preferably within the range of 1:10 to 2:1, more preferably 1:5 to 1:1.

The content of the acryl polymer is preferably 1 to 50 parts by mass, more preferably 5 to 40 parts by mass, with respect to 100 parts by mass of silica.

Although a number of emulsion type adhesives and water soluble adhesives are generally known, the inventors of the present invention, after diligent search, found that clear image may be obtained when dye ink as well as pigment ink are used and that the preservability for white paper portion may become excellent if an emulsion type adhesive of acryl polymer is used.

Note that such emulsion type adhesives typically used for an ink jet recording sheet, for instance, ethylene-vinyl acetate copolymer, vinyl acetate polymer, urethane polymer, and styrene-butadiene copolymer, are all inferior to the acryl copolymer from the viewpoint or print coloring property, and urethane polymer and styrene-butadiene copolymer have problems that the yellowing of white paper portion tends to be readily generated and the preservability is not good.

Also, if only the water soluble adhesives, such as starch and polyvinyl alcohol, are used, problems tend to occur that a sufficient coating strength cannot be obtained and that a clear image cannot be obtained because an ink receiving layer coating solution of high concentration cannot be prepared and hence the coating amount will be reduced.

(Cationic Ink Fixing Agent)

According to the present invention, the cationic ink fixing agent used in the ink receiving layer in not particularly limited, and examples thereof include commercially available:
1) polyalkylene polyamines or derivatives thereof, such as polyethylene amine and polypropylene polyamine;
2) acryl polymers having a secondary amino group, a tertiary amine group and/or a quaternary ammonium group;
3) polyvinyl amine, polyvinyl amidine, and 5-member ring amidines;
4) dicyan (cyanogen) cationic resins, represented by dicyandiamide-formalin copolymer;
5) polyamine cationic resins, represented by dicyandiamide-polyethylene amine copolymer;
6) dimethylamine-epochlorhydrin copolymer;
7) diallydimethylammonium-SO₂ copolymer;
8) diallylamine-SO₂ copolymer;
9) dimethyldiallylammonium chloride polymer;
10) polymer of allyl amine salt;
11) dialkylaminoethyl(meth)acrylate quaternary salt copolymer;
12) acrylamide-diallylamine salt copolymer;
13) aluminum salts, such as aluminum polychloride and aluminum polylactate; and
14) water soluble metal salt, such as zinc sulfate.
   These may be used alone or in a mixture of two or more.

Among the above, it is preferable, as a cationic ink fixing agent, to use dicyandiamide-polyethylene amine copolymer with acrylamide-diallylamine copolymer. The combination is preferable because by using the dicyandiamide-polyethylene amine copolymer with the acrylamide-diallylamine copolymer, the coloring property when recorded using pigment ink as well as dye ink will be improved and the preservability of portions printed by using dye ink will be enhanced. Also, it is preferable to include zinc sulfate in the combination since the coloring property, especially when printed using pigment ink, will be significantly improved.

The amount of the cationic ink fixing agent is preferably 5 to 60 parts by mass, more preferably 20 to 50 parts by mass, with respect to 100 parts by mass of silica. If the amount of the cationic ink fixing agent is less than 5 parts by mass, the coloring property of images and the preservability of printed portion will be easily deteriorated. If the amount of the cationic polymer exceeds 60 parts by mass, on the other hand, the ink absorptivity and the clearness of image will be deteriorated and uneven color will be easily caused.

It is possible to add various auxiliary agents, which are generally used for producing coated paper, in a suitable amount, to the ink receiving layer, such as a thickener, an antifoamer, a wetting agent, a surfactant, a coloring agent, an antistatic agent, a light resistance auxiliary agent, an UV absorber, an antioxidizing agent, and an antiseptic agent.

According to an ink jet recording sheet of the present invention, a high degree of brightness may be realized even if an ink receiving layer does not substantially contain a fluorescent brightener.

Such an ink receiving layer may be formed by applying an ink receiving layer coating solution which includes the above-mentioned silica, adhesive, cationic ink fixing agent, and auxiliary agent if necessary, onto the surface of an undercoating layer, which is formed on a paper supporting medium, and drying the coating solution.

Although the coating amount of the ink receiving layer is not particularly limited, it is preferably 2 to 30 g/m², and more preferably 5 to 20 g/m². If the coating amount is smaller than the above-mentioned lower limit, the ink absorptivity, clearness of image, and print preservability tend to be easily lowered, and if the coating amount is larger than the above-mentioned upper limit, on the other hand, the strength of coating film and clearness of image tend to be easily lowered.

Note that the ink receiving layer may be formed of a plurality of layers as described above, and in such case, the compositions of each layer may be different from each other.

The ink receiving layer may be formed by using various known application devices, such as a blade coater, an air knife coater, a roll coater, a bar coater, a gravure coater, a rod blade coater, a lip coater, a curtain coater, and a die coater. It is possible, after the coating process, to carry out a finishing process using a calender device, such as a machine calender, a super calender, and a soft calender.

(Printed Matter)

Printed matter may be produced by printing the ink jet recording sheet explained above with dye ink or pigment ink using a printing device, such as a printer.

Note that according to the present invention, excellent coloring properties and sufficient print concentration may be obtained by using dye ink as well as pigment ink, and it becomes possible to achieve excellent clearness of image. Also, printed matter having an excellent preservability (e.g., light resistance, ozone resistance, and water resistance) for printed portions and for white paper portions may be obtained when dye ink as well as pigment ink is used, and the printed matter thus obtained is suitable for a wide range of use including exhibition outdoors.

### EXAMPLES

Hereinafter, the present invention will be explained in detail with reference to Examples. However, it is apparent that the present invention is not limited to these Examples. Also, “parts” and “%” used in the examples indicate “parts by mass” and “% by mass” of a solid component excluding water unless otherwise so indicated. Moreover, the term “secondary particle size” means an average secondary particle size.

### Example 1

<Paper Supporting Medium A>

Precipitated calcium carbonate (20 parts) was added to a slurry of 100 parts of L-bleached kraft pulp (freeness 400 ml CSF), and 1 part of cation starch (a product of Oji Cornstarch Co., Ltd., product name: Ace K) and 0.2 parts of alkenylsuccinic anhydride type neutral sizing agent (a product of National Starch and Chemical Co., Ltd., product name: Phibrun 81K) were added, sufficiently mixed, and paper raw material was obtained. This was dried using a Fourdrinier multi-cylinder paper machine until the water content thereof became 10%. Then, 7% solution including oxidized starch was applied to both sides thereof in an amount of 4 g/m² using a size press, and this was dried until water components thereof became 7% to produce a paper supporting medium A of 200 g/m².

<Undercoating Layer Coating Solution A>

An undercoating layer coating solution A was prepared by dispersing 100 parts of titanium dioxide (a product of Sakai Chemical Industry Co. Ltd., product name: R-21, secondary particle size of 0.5 μm, rutile type) as pigment, 10 parts of an acryl polymer (a product of Rohm and Haas, product name: Primal P-376, emulsion type adhesive) and 5 parts of oxidized starch (a product of Oji Cornstarch Co., Ltd, product name: Ace A, a water soluble adhesive) as adhesive in water.

(Ink Receiving Layer Coating Solution A)

An ink receiving layer coating solution A was prepared by dispersing 100 parts of wet silica (a product of Tokuyama Corporation, product name: Finesil X-60) as pigment, 20 parts of silyl denatured polyvinyl alcohol (a product of Kuraray Co. Ltd., product name: R-1130) and 20 parts of an acryl polymer (a product of Rohm and Haas, product name: Primal P-376) as adhesive, and 15 parts of acrylamide-diallyl amine copolymer (a product of Sumitomo Chemical Co. Ltd., product name: SR 1001) and 15 parts of dicyandiamide-polyethylene amine copolymer (a product of Nicca Chemical Co. Ltd., product name: Neofix IJ-117) as ink fixing agents in water.

<Preparation of Ink Jet Recording Sheet>

The undercoating layer coating solution A was applied onto the paper supporting medium A so that the coating amount became 10 g/m², and after the coating solution was dried, the ink receiving layer coating solution A was applied thereon so that the coating amount became 10 g/m². This was dried to obtain an ink jet recording sheet. The 60° specular surface gloss of a white paper portion in the ink receiving layer of the obtained ink jet recording sheet based on JIS-Z8741 was 3%.

### Example 2

<Paper Supporting Medium B>

Precipitated calcium carbonate (20 parts) was added to a mixed slurry including 70 parts of Lbleached kraft pulp (freeness: 400 ml CSF) and 30 parts of pulp obtained by subjecting waste newspaper to a deinking process (freeness: 250 ml), and 1 part of cation starch (a product of Oji Cornstarch Co., Ltd., product name: Ace K) and 0.2 parts of alkenylsuccinic anhydride type neutral sizing agent (a product of National Starch and Chemical Co., Ltd., product name: Phibrun 81K) were added, sufficiently mixed, and paper raw material was obtained. This was dried using a Fourdrinier multi-cylinder paper machine until the water content thereof became 10%. Then, 7% solution including oxidized starch was applied to both sides thereof in an amount of 4 g/m² using a size press, and this was dried until water components thereof became 7% to produce a paper supporting medium B of 200 g/m².

<Preparation of Ink Jet Recording Sheet>

An ink jet recording sheet was obtained in the same manner as in Example 1 except that the paper supporting medium A in Example 1 was changed to the paper supporting medium B. The 60° specular surface gloss of a white paper portion in the ink receiving layer of the obtained ink jet recording sheet based on JIS-Z8741 was 3%.

### Example 3

<Paper Supporting Medium C>

Precipitated calcium carbonate (20 parts) was added to a mixed slurry including 70 parts of L-bleached kraft pulp (freeness: 400 ml CSF) and 30 parts of pulp obtained by subjecting waste colored paper (including colored woodfree paper and art paper) to a deinking process (freeness: 250 ml), and 1 part of cation starch (a product of Oji Cornstarch Co., Ltd., product name: Ace K) and 0.2 parts of alkenylsuccinic anhydride type neutral sizing agent (a product of National Starch and Chemical Co., Ltd., product name: Phibrun 81K) were added, sufficiently mixed, and paper raw material was obtained. This was dried using a Fourdrinier multi-cylinder paper machine until the water content thereof became 10%. Then, 7% solution including oxidized starch was applied to both sides thereof in an amount of 4 g/m² using a size press, and this was dried until water components thereof became 7% to produce a paper supporting medium C of 200 g/m².

<Preparation of Ink Jet Recording Sheet>

An ink jet recording sheet was obtained in the same manner as in Example 1 except that the paper supporting medium A in Example 1 was changed to the paper supporting medium C. The 60° specular surface gloss of a white paper portion in the ink receiving layer of the obtained ink jet recording sheet based on JIS-Z8741 was 3%.

### Example 4

<Paper Supporting Medium D>

Precipitated calcium carbonate (20 parts) was added to a mixed slurry including 70 parts of L-bleached kraft pulp (freeness: 400 ml CSF) and 30 parts of pulp obtained by subjecting waste woodfree white paper (the term includes white unprinted portion of woodfree paper of binder's waste and broke generated during a binding process, printing process, etc.) to a defiberizing process (freeness: 250 ml), and 1 part of cation starch (a product of Oji Cornstarch Co., Ltd., product name: Ace K) and 0.2 parts of alkenylsuccinic anhydride type neutral sizing agent (a product of National Starch and Chemical Co., Ltd., product name: Phibrun 81K) were added, sufficiently mixed, and paper raw material was obtained. This was dried using a Fourdrinier multi-cylinder paper machine until the water content thereof became 10%. Then, 7% solution including oxidized starch was applied to both sides thereof in an amount of 4 g/m² using a size press, and this was dried until water components thereof became 7% to produce a paper supporting medium D of 200 g/m².

<Preparation of Ink Jet Recording Sheet>

An ink jet recording sheet was obtained in the same manner as in Example 1 except that the paper supporting medium A in Example 1 was changed to the paper supporting medium D. The 60° specular surface gloss of a white paper portion in the ink receiving layer of the obtained ink jet recording sheet based on JIS-Z8741 was 3%.

### Example 5

<Undercoating Layer Coating Solution B>

An undercoating layer coating solution B was prepared by dispersing 100 parts of titanium dioxide (a product of Sakai Chemical Industry Co. Ltd., product name: R-21, secondary particle size of 0.5 μm, rutile type) as pigment, 10 parts of an ethylene-vinyl acetate copolymer (a product of Showa Highpolymer Co. Ltd., product name: Polysol AM-3000, an emulsion type adhesive) and 5 parts of oxidized starch (a product of Oji Cornstarch Co., Ltd, product name: Ace A, a water soluble adhesive) as adhesive in water.

<Preparation of Ink Jet Recording Sheet>

The undercoating layer coating solution B was applied onto the paper supporting medium B so that the coating amount became 10 g/m², and after the coating solution was dried, the ink receiving layer coating solution A was applied thereon so that the coating amount became 10 g/m². This was dried to obtain an ink jet recording sheet. The 60° specular surface gloss of a white paper portion in the ink receiving layer of the obtained ink jet recording sheet based on JIS-Z8741 was 3%.

### Example 6

<Undercoating Layer Coating Solution C>

An undercoating layer coating solution C was prepared by dispersing 100 parts of titanium dioxide (a product of Sakai Chemical Industry Co. Ltd., product name: R-21, secondary particle size of 0.5 μm, rutile type) as pigment, 10 parts of a vinyl acetate polymer (a product of Nissin Chemical Industry Co., Ltd., product name: Vinyblan 1080, an emulsion type adhesive) and 5 parts of oxidized starch (a product of Oji Cornstarch Co., Ltd, product name: Ace A, a water soluble adhesive) as adhesive in water.

<Preparation of Ink Jet Recording Sheet>

The undercoating layer coating solution C was applied onto the paper supporting medium B so that the coating amount became 10 g/m², and after the coating solution was dried, the ink receiving layer coating solution A was applied thereon so that the coating amount became 10 g/m². This was dried to obtain an ink jet recording sheet. The 60° specular surface gloss of a white paper portion in the ink receiving layer of the obtained ink jet recording sheet based on JIS-Z8741 was 3%.

### Example 7

<Preparation of Surface Treated Silica>

Wet silica (900 g, a product of Tokuyama Corporation, product name: Finesil X-60) was suspended in water to obtain a slurry (about 10 to 15%), and 100 g of a water-suspension of a surfactant (polyoxyethylenelauryl ether, a product of Dai-ichi Kogyo Seiyaku Co. Ltd., product name: Noigen ET-102, HLB: 10.8) was added to the slurry. The mixture was stirred for one hour, spray-dried, pulverized, and classified to obtain the surface treated silica. The average secondary particle size of the obtained surface treated silica was 6 μm.

<Ink Receiving Layer Coating Solution B>

Wet silica (80 parts, a product of Tokuyama Corporation, product name: Finesil X-60, secondary particle size of 6.2 μm) and 20 parts of the surface treated silica obtained as above as pigment, silyl denatured polyvinyl alcohol (20 parts, a product of Kuraray Co. Ltd., product name: R-1130) and 20 parts of an acryl polymer (a product of Rohm and Haas, product name: Primal P-376) as adhesive, and acrylamide-diallyl amine copolymer (15 parts, a product of Sumitomo Chemical Co. Ltd., product name: SR 1001) and dicyandiamide-polyethylene amine copolymer (15 parts, a product of Nicca Chemical Co. Ltd., product name: Neofix IJ-117) as ink fixing agents were dispersed in water to obtain the ink receiving layer coating solution B.

<Preparation of Ink Jet Recording Sheet>

The undercoating layer coating solution A was applied onto the paper supporting medium B so that the coating amount became 10 g/m², and after the coating solution was dried, the ink receiving layer coating solution B was applied thereon so that the coating amount became 10 g/m². This was dried to obtain an ink jet recording sheet. The 60° specular surface gloss of a white paper portion in the ink receiving layer of the obtained ink jet recording sheet based on JIS-Z8741 was 3%.

### Example 8

<Ink Receiving Layer Coating Solution C>

Wet silica (80 parts, a product of Tokuyama Corporation, product name: Finesil X-60, secondary particle size of 6.2 μm) as pigment, silyl denatured polyvinyl alcohol (20 parts, a product of Kuraray Co. Ltd., product name: R-1130) and 20 parts of an acryl polymer (a product of Rohm and Haas, product name: Primal P-376) as adhesive, and acrylamide-diallyl amine copolymer (25 parts, a product of Sumitomo Chemical Co. Ltd., product name: SR 1001) and dicyandiamide-polyethylene amine copolymer (5 parts, a product of Nicca Chemical Co. Ltd., product name: Neofix IJ-117) as ink fixing agents were dispersed in water to obtain the ink receiving layer coating solution C.

<Preparation of Ink Jet Recording Sheet>

The undercoating layer coating solution A was applied onto the paper supporting medium B so that the coating amount became 10 g/m², and after the coating solution was dried, the ink receiving layer coating solution C was applied thereon so that the coating amount became 10 g/m². This was dried to obtain an ink jet recording sheet. The 60° specular surface gloss of a white paper portion in the ink receiving layer of the obtained ink jet recording sheet based on JIS-Z8741 was 3%.

### Comparative Example 1

<Preparation of Ink Jet Recording Sheet>

The undercoating layer coating solution A was applied onto the paper supporting medium B so that the coating amount became 10 g/m², and dried to obtain an ink jet recording sheet having no undercoating layer. The 60° specular surface gloss of a white paper portion in the ink receiving layer of the obtained ink jet recording sheet based on JIS-Z8741 was 3%.

### Comparative Example 2

<Undercoating Layer Coating Solution D>

Wet silica (100 parts, a product of Tokuyama Corporation, product name: Finesil X-60, secondary particle size of 6.2 μm) as pigment, and 10 parts of an acryl polymer (a product of Rohm and Haas, product name: Primal P-376, an emulsion type adhesive) and 5 parts of oxidized starch (a product of Oji Cornstarch Co., Ltd, product name: Ace A, a water soluble adhesive) as adhesive were dispersed in water to obtain the undercoating layer coating solution D.

<Preparation of Ink Jet Recording Sheet>

The undercoating layer coating solution D was applied onto the paper supporting medium B so that the coating amount became 10 g/m², and after the coating solution was dried, the ink receiving layer coating solution A was applied thereon so that the coating amount became 10 g/m². This was dried to obtain an ink jet recording sheet. The 60° specular surface gloss of a white paper portion in the ink receiving layer of the obtained ink jet recording sheet based on JIS-Z8741 was 3%.

### Comparative Example 3

<Ink Receiving Layer Coating Solution D>

Wet silica (100 parts, a product of Tokuyama Corporation, product name: Finesil X-60, secondary particle size of 6.2 μm) as pigment, 20 parts of silyl denatured polyvinyl alcohol (a product of Kuraray Co. Ltd., product name: R-1130) and 20 parts of an acryl polymer (a product of Rohm and Haas, product name: Primal P-376, an emulsion type adhesive) as adhesive, and 30 parts of polydiallyldimethylammonium chloride (a product of Senka Co. Ltd., product name: Unisence CP101) as ink fixing agent were dispersed in water to obtain the ink receiving layer coating solution D.

<Preparation of Ink Jet Recording Sheet>

The undercoating layer coating solution D was applied onto the paper supporting medium B so that the coating amount became 10 g/m², and after the coating solution was dried, the ink receiving layer coating solution D was applied thereon so that the coating amount became 10 g/m². This was dried to obtain an ink jet recording sheet. The 60° specular surface gloss of a white paper portion in the ink receiving layer of the obtained ink jet recording sheet based on JIS-Z8741 was 3%.

### Comparative Example 4

<Undercoating Layer Coating Solution E>

Calcium carbonate (100 parts, a product of Okutama Kogyo Co., Ltd., product name: TP-121, shape: spindle, standard particle size of 0.5×1.5 μm) as pigment, and 10 parts of an acryl polymer (a product of Rohm and Haas, product name: Primal P-376, an emulsion type adhesive) and 5 parts of oxidized starch (a product of Oji Cornstarch Co., Ltd, product name: Ace A, a water soluble adhesive) as adhesive were dispersed in water to obtain the undercoating layer coating solution E.

<Preparation of Ink Jet Recording Sheet>

The undercoating layer coating solution E was applied onto the paper supporting medium B so that the coating amount became 10 g/m², and after the coating solution was dried, the ink receiving layer coating solution A was applied thereon so that the coating amount became 10 g/m². This was dried to obtain an ink jet recording sheet. The 60° specular surface gloss of a white paper portion in the ink receiving layer of the obtained ink jet recording sheet based on JIS-Z8741 was 3%.

### Comparative Example 5

<Undercoating Layer Coating Solution E>

Titanium dioxide (100 parts, a product of Sakai Chemical Industry Co. Ltd., product name: R-21, secondary particle size of 0.5 μm, rutile type) as pigment, 10 parts of styrene-butadiene rubber (SBR) (a product of JSR Co., Ltd., product name: 0589, Tg: 0° C., an emulsion type adhesive) and 5 parts of oxidized starch (a product of Oji Cornstarch Co., Ltd, product name: Ace A, a water soluble adhesive) as adhesive were dispersed in water to obtain the undercoating layer coating solution F.

<Preparation of Ink Jet Recording Sheet>

The undercoating layer coating solution F was applied onto the paper supporting medium B so that the coating amount became 10 g/m², and after the coating solution was dried, the ink receiving layer coating solution A was applied thereon so that the coating amount became 10 g/m². This was dried to obtain an ink jet recording sheet. The 60° specular surface gloss of a white paper portion in the ink receiving layer of the obtained ink jet recording sheet based on JIS-Z8741 was 3%.

### Comparative Example 6

<Ink Receiving Layer Coating Solution E>

Wet silica (100 parts, a product of Tokuyama Corporation, product name: Finesil F80, secondary particle size of 1.8 μm) as pigment, 20 parts of silyl denatured polyvinyl alcohol (a product of Kuraray Co. Ltd., product name: R-1130) and 20 parts of an acryl polymer (a product of Rohm and Haas, product name: Primal P-376, an emulsion type adhesive) as adhesive, and 15 parts of acrylamide-diallyl amine copolymer (a product of Sumitomo Chemical Co. Ltd., product name: SR 1001) and 15 parts of dicyandiamide-polyethylene amine copolymer (a product of Nicca Chemical Co. Ltd., product name: Neofix U-117) as ink fixing agents were dispersed in water to obtain the ink receiving layer coating solution E.

<Preparation of Ink Jet Recording Sheet>

The undercoating layer coating solution A was applied onto the paper supporting medium B so that the coating amount became 10 g/m², and after the coating solution was dried, the ink receiving layer coating solution E was applied thereon so that the coating amount became 10 g/m². This was dried to obtain an ink jet recording sheet. The 60° specular surface gloss of a white paper portion in the ink receiving layer of the obtained ink jet recording sheet based on JIS-Z8741 was 4%.

### Comparative Example 7

<Ink Receiving Layer Coating Solution F>

Wet silica (100 parts, a product of Mizusawa Chemical Co. Ltd., product name: Mizukasil P-78F, secondary particle size of 12.5 μm, oil absorption amount of 230 cm³/100 g) as pigment, 20 parts of silyl denatured polyvinyl alcohol (a product of Kuraray Co. Ltd., product name: R-1130) and 20 parts of an acryl polymer (a product of Rohm and Haas, product name: Primal P-376, an emulsion type adhesive) as adhesive, and 15 parts of acrylamide-diallyl amine copolymer (a product of Sumitomo Chemical Co. Ltd., product name: SR 1001) and 15 parts of dicyandiamide-polyethylene amine copolymer (a product of Nicca Chemical Co. Ltd., product name: Neofix IJ-117) as ink fixing agents were dispersed in water to obtain the ink receiving layer coating solution F.

<Preparation of Ink Jet Recording Sheet>

The undercoating layer coating solution A was applied onto the paper supporting medium B so that the coating amount became 10 g/m², and after the coating solution was dried, the ink receiving layer coating solution F was applied thereon so that the coating amount became 10 g/m². This was dried to obtain an ink jet recording sheet. The 60° specular surface gloss of a white paper portion in the ink receiving layer of the obtained ink jet recording sheet based on JIS-Z8741 was 3%.

### Example 9

<Ink Receiving Layer Coating Solution E>

Wet silica (100 parts, a product of Tokuyama Corporation, product name: Finesil X-60, secondary particle size of 6.2 μm, oil absorption amount of 240 cm³/100 g) as pigment, 20 parts of silyl denatured polyvinyl alcohol (a product of Kuraray Co. Ltd., product name: R-1130) and 20 parts of an acryl polymer (a product of Rohm and Haas, product name: Primal P-376, an emulsion type adhesive) as adhesive, 15 parts of acrylamide-diallyl amine copolymer (a product of Sumitomo Chemical Co. Ltd., product name: SR 1001) and 15 parts of dicyandiamide-polyethylene amine copolymer (a product of Nicca Chemical Co. Ltd., product name: Neofix IJ-117) as ink fixing agents, and an aqueous solution of zinc sulfate (a product of Wako Pure Chemical Industries, Ltd., a 5% solution was prepared by dissolving zinc sulfate 7 hydrate in water, Molecular weight: 287.56) were dispersed in water to obtain the ink receiving layer coating solution G.

<Preparation of Ink Jet Recording Sheet>

The undercoating layer coating solution A was applied onto the paper supporting medium B so that the coating amount became 10 g/m², and after the coating solution was dried, the ink receiving layer coating solution G was applied thereon so that the coating amount became 10 g/m². This was dried to obtain an ink jet recording sheet. The 60° specular surface gloss of a white paper portion in the ink receiving layer of the obtained ink jet recording sheet based on JIS-Z8741 was 4%.

Evaluation:

The degree of brightness, preservability of white paper portion (yellowing resistance against heat, light and ozone), print concentration, ink absorption, ink fixation, and preservability of printed portion (light resistance, ozone resistance and water resistance) of the ink jet recording sheet obtained in each of Examples and Comparative Examples were evaluated by the methods described below. Results of the evaluation are tabulated in Table 1.

Note that the ink jet recording sheet of Examples and Comparative Examples were printed using four types of commercially available printers, i.e., a dye ink jet printer (a product of SEIKO EPSON Corporation, trade name: PM-G800; print mode: Fotomat paper/high fineness), a pigment ink jet printer (a product of SEIKO EPSON Corporation, trade name: PX-G900; print mode: Fotomat paper/high fineness), a pigment ink jet printer (a product of SEIKO EPSON Corporation, trade name: PM-4000PX; ink: Mat black; print mode: Fotomat paper/high fineness), and a pigment ink jet printer (a product of SEIKO EPSON Corporation, trade name: PX-V600; print mode: Fotomat paper/clean).

(Degree of Brightness)

The degree of brightness at a white paper portion of an ink receiving layer side of the ink jet recording sheet of each Example and Comparative Example was measured in accordance with a method defined in JIS-P8123.

(Preservability of White Paper Portion (Yellowing Resistance Against Heat)

The ink jet recording sheet of each Example and Comparative Example was left for one week under an environment of 80° C. and 50% humidity. The hue b* value of a white paper portion at the ink receiving layer side of each sheet before and after the test was measured using 938 spectrodenstiometer (a product of X-rite Co. Ltd.). Then, Δb* value was calculated based on the following equation:
Δb*value=|b*value after being left for 1 week|−|b*value before being left for 1 week|

The preservability (yellowing resistance against heat) of white paper portion was evaluated based on the criteria described below:
∘: Δb* value is less than 3, and almost no yellowing was caused;
Δ: Δb* value is 3 or greater and less than 6, and yellowing was caused; and
X: Δb* value is 6 or greater, and abundant yellowing was caused.
   (Preservability of White Paper Portion (Yellowing Resistance Against Light)

The ink jet recording sheet of each Example and Comparative Example was irradiated by a xenon lamp (100,000 lux) for three days under an environment of 60° C. and 50% humidity. The hue b* value of a white paper portion at the ink receiving layer side of each sheet before and after the irradiation was measured using 938 spectrodenstiometer (a product of X-rite Co. Ltd.). Then, Δb* value was calculated based on the following equation:
Δb*value=|b*value after irradiation|−|b*value before irradiation|

The preservability (yellowing resistance against light) of white paper portion was evaluated based on the criteria described below:
∘: Δb* value is less than 3, and almost no yellowing was caused;
Δ: Δb* value is 3 or greater and less than 6, and yellowing was caused; and
X: Δb* value is 6 or greater, and abundant yellowing was caused.
   (Preservability of White Paper Portion (Yellowing Resistance Against Ozone)

The ink jet recording sheet of each Example and Comparative Example was left for 24 hours in an atmosphere in which the concentration of ozone was 10 ppm under an environment of 24° C. and 60% humidity. The hue b* value of a white paper portion at the ink receiving layer side of each sheet before and after the test was measured using 938 spectrodenstiometer (a product of X-rite Co. Ltd.). Then, Δb* value was calculated based on the following equation:
Δb*value=|b*value after being left for 1 day|−|b*value before being left for 1 day|

The preservability (yellowing resistance against ozone) of white paper portion was evaluated based on the criteria described below:
∘: Δb* value is less than 3, and almost no yellowing was caused;
Δ: Δb* value is 3 or greater and less than 6, and yellowing was caused; and
X: Δb* value is 6 or greater, and abundant yellowing was caused.
   (Print Concentration)

Image issued by Japanese Standards Association (high fineness color digital standard image XYZ/JIS-SCID), Identification Number: S6; Image title: Color Chart) was printed using the above-mentioned four types of ink jet printers, and the print concentration of the best black tone portion was measured using a measuring device of “RD-914”, a product of Gretag Macbeth Co.

(Ink Absorptivity)

Among the ink jet printing sheet whose print concentration was evaluated as described above, the best black tone portion of a printed matter printed by using the dye ink jet printer (a product of SEIKO EPSON Corporation, trade name: PM-G800; print mode: Fotomat paper/high fineness) was observed, and evaluated as follows:
∘: no overflow, feathering, or unevenness of ink; and
X: overflow and unevenness of ink was caused.
   (Ink Fixation)

Among the ink jet printing sheet whose print concentration was evaluated as described above, the best black tone portion of a printed matter printed by using the pigment ink jet printer (a product of SEIKO EPSON Corporation, trade name: PM-4000PX; ink: Mat black; print mode: Fotomat paper/high fineness) was rubbed by a finger 24 hours after the printing, and evaluated as follows:
∘: no change of printed portion and excellent ink fixation was observed; and
X: printed portion was rubbed and ink fixation was no good.
   (Preservability of Printed Portion (Light Resistance)

Printed matter obtained by using the dye ink jet printer (a product of SEIKO EPSON Corporation, trade name: PM-G800; print mode: Fotomat paper/high fineness) in which the magenta print concentration was adjusted to be 1.0, was irradiated with a fluorescent lamp having illuminance of 70 klux under the conditions of 24° C. and 60% RH for 500 hours and the print concentration thereof was measured. Note that a glass having a thickness of 2 mm was placed on the printed matter. The preservability (light resistance) of the printed portion was evaluated based on the following criteria:
⊚: change in concentration was less than 15%;
∘: change in concentration was 15% or more and less than 20%;
Δ: change in concentration was 20% or more and less than 30%; and
X: change in concentration was 30% or more.
   (Preservability of Printed Portion (Ozone Resistance)

Printed matter obtained by using the dye ink jet printer (a product of SEIKO EPSON Corporation, trade name: PM-G800; print mode: Fotomat paper/high fineness) in which the magenta print concentration was adjusted to be 1.0, was left for 24 hours in an atmosphere in which the concentration of ozone was 10 ppm under an environment of 24° C. and 60% humidity. After this, the print concentration thereof was measured. The preservability (ozone resistance) of the printed portion was evaluated based on the following criteria:
∘: change in concentration was less than 15%;
Δ: change in concentration was 15% or more and less than 30%; and
X: change in concentration was 30% or more.
   (Preservability of Printed Portion (Water Resistance)

Characters of 30 points were printed by using the dye ink jet printer (a product of SEIKO EPSON Corporation, trade name: PM-G800; print mode: Fotomat paper/high fineness) at the best black concentration. Then, a water drop was placed on the characters and naturally dried. The preservability (water resistance) of the printed portion was evaluated based on the following criteria:
⊚: absolutely no feathering was caused;
∘: slight feathering was observed but no problem for recognizing the character;
Δ: feathering was caused and some difficulty in recognizing the character; and

X: significant feathering was caused and difficult to recognize the character.

TABLE 1

| | | Preservability | | | | | | |
|---|---|---|---|---|---|---|---|---|
| | Degree | of white | | | | | | |
| | of | paper portion | | | Print concentration | | | |
| | bright- | Vs. | vs. | vs. | PM- | PX- | PM- | PX- |
| | ness | heat | light | ozone | G800 | G900 | 4000PX | V600 |
| Ex. 1 | 92% | ◯ | ◯ | ◯ | 1.82 | 1.78 | 1.78 | 1.66 |
| Ex. 2 | 85% | ◯ | ◯ | ◯ | 1.82 | 1.78 | 1.78 | 1.66 |
| Ex. 3 | 88% | ◯ | ◯ | ◯ | 1.82 | 1.78 | 1.78 | 1.66 |
| Ex. 4 | 92% | ◯ | ◯ | ◯ | 1.82 | 1.78 | 1.78 | 1.66 |
| Ex. 5 | 85% | ◯ | ◯ | ◯ | 1.82 | 1.78 | 1.78 | 1.66 |
| Ex. 6 | 85% | ◯ | ◯ | ◯ | 1.82 | 1.78 | 1.78 | 1.66 |
| Ex. 7 | 85% | ◯ | ◯ | ◯ | 1.85 | 1.83 | 1.83 | 1.69 |
| Ex. 8 | 85% | ◯ | ◯ | ◯ | 1.80 | 1.76 | 1.76 | 1.65 |
| Ex. 9 | 85% | ◯ | ◯ | ◯ | 1.85 | 1.83 | 1.83 | 1.72 |
| C. Ex. 1 | 75% | X | X | ◯ | 1.78 | 1.73 | 1.73 | 1.62 |
| C. Ex. 2 | 77% | Δ | X | ◯ | 1.80 | 1.75 | 1.75 | 1.64 |
| C. Ex. 3 | 77% | ◯ | X | ◯ | 1.84 | 1.65 | 1.65 | 1.52 |
| C. Ex. 4 | 80% | X | Δ | ◯ | 1.78 | 1.75 | 1.75 | 1.64 |
| C. Ex. 5 | 85% | Δ | Δ | ◯ | 1.79 | 1.75 | 1.75 | 1.63 |
| C. Ex. 6 | 87% | ◯ | ◯ | ◯ | 2.10 | 2.08 | 2.08 | 1.96 |
| C. Ex. 7 | 84% | ◯ | ◯ | ◯ | 1.62 | 1.58 | 1.58 | 1.46 |

| | Ink absorptivity | Ink fixation | Preservability of printed portion | | |
|---|---|---|---|---|---|
| | PM-G800 | PM-4000PX | vs. light | vs. ozone | vs. water |
| Ex. 1 | ◯ | ◯ | ◯ | ◯ | ◯ |
| Ex. 2 | ◯ | ◯ | ◯ | ◯ | ◯ |
| Ex. 3 | ◯ | ◯ | ◯ | ◯ | ◯ |
| Ex. 4 | ◯ | ◯ | ◯ | ◯ | ◯ |
| Ex. 5 | ◯ | ◯ | ◯ | ◯ | ◯ |
| Ex. 6 | ◯ | ◯ | ◯ | ◯ | ◯ |
| Ex. 7 | ◯ | ◯ | ◯ | ◯ | ◯ |
| Ex. 8 | ◯ | ◯ | ⊚ | ◯ | ◯ |
| Ex. 9 | ◯ | ◯ | ◯ | ◯ | ◯ |
| C. Ex. 1 | ◯ | ◯ | ◯ | ◯ | ◯ |
| C. Ex. 2 | ◯ | ◯ | ◯ | ◯ | ◯ |
| C. Ex. 3 | ◯ | ◯ | Δ | X | ⊚ |
| C. Ex. 4 | ◯ | ◯ | ◯ | ◯ | ◯ |
| C. Ex. 5 | ◯ | ◯ | ◯ | ◯ | ◯ |
| C. Ex. 6 | X | X | Δ | Δ | X |
| C. Ex. 7 | ◯ | ◯ | ◯ | Δ | ◯ |

As is clearly shown in Table 1 above, it is obvious that all of the ink jet recording sheets according to the present invention in which the undercoating layer includes titanium dioxide as pigment and at least one emulsion type adhesive selected from acryl polymers, ethylene-vinyl acetate copolymers, or vinyl acetate polymers as the adhesive, and the ink receiving layer includes silica having an average secondary particle size of 3 to 11 μm as pigment and a cationic ink fixing agent, have an excellent degree of brightness, superb preservability for white paper portions as well as printed portions, and excellent coloring property for dye ink as well as pigment ink. Also, it becomes clear that the excellent properties thereof may be maintained even if pulp recycled from various kinds of waste paper is used for the paper supporting medium in consideration of the environmental protection. Moreover, it becomes apparent that when acrylamide-diallyl amine copolymer is used together with dicyandiamide-polyethylene amine copolymer as the cationic ink fixing agent, the preservability for, in particular, printed portions becomes excellent. Furthermore, it was found that when zinc sulfate or surface treated silica whose surface is treated with a surfactant is used, the coloring property of the ink jet recording sheet is significantly improved.

On the other hand, when silica or calcium carbonate was used as pigment for the undercoating layer, or SBR was used as adhesive for the undercoating layer, or a fluorescent brightener was used for the ink receiving layer, significant deterioration of the preservability for white paper portions was observed. Also, when the average particle size of silica for the ink receiving layer was less than 3 μm or larger than 11 μm, reduction of ink absorptivity and ink fixation was observed and the coloring property was significantly deteriorated.

Having thus described exemplary embodiments of the invention, it will be apparent that various alterations, modifications, and improvements will readily occur to those skilled in the art. Such alterations, modifications, and improvements, though not expressly described above, are nonetheless intended and implied to be within the spirit and scope of the invention. Accordingly, the foregoing discussion is intended to be illustrative only: the invention is limited and defined only by the following claims and equivalents thereto.

1. Ink jet recording sheet, comprising:
a paper supporting medium made by machining pulp;
an undercoating layer including at least a pigment and an adhesive; and
an ink receiving layer including at least a pigment and an adhesive, said undercoating layer and said ink receiving layer being disposed on at least one surface of said paper supporting medium, and said undercoating layer being sandwiched between said paper supporting medium and said ink receiving layer, wherein
said undercoating layer comprises titanium dioxide as said pigment and at least one emulsion type adhesive selected from the group consisting of acryl polymers, ethylene-vinyl acetate copolymers, and vinyl acetate polymers as said adhesive; and
said ink receiving layer comprises silica having an average secondary particle size of 3 to 11 μm as said pigment, and a cationic ink fixing agent.

2. The ink jet recording sheet according to claim 1, wherein 10% by mass or more of said pulp is recycled pulp obtained from waste paper.

3. The ink jet recording sheet according to claim 1, wherein said cationic ink fixing agent comprises a dicyandiamide-polyethylene amine copolymer and an acrylamide-diallyl amine copolymer.

4. The ink jet recording sheet according to claim 3, wherein said cationic ink fixing agent further comprises zinc sulfate.

5. The ink jet recording sheet according to claim 1, wherein said ink receiving layer comprises at least an acryl copolymer as said adhesive.

6. The ink jet recording sheet according to claim 1, wherein at least a part of said silica is surface treated silica whose surface is treated by a surfactant.

7. The ink jet recording sheet according to claim 1, wherein a 60° specular gloss defined by JIS-Z8741 of a surface of said ink receiving layer is 15% or less.

8. Printed matter including the ink jet recording sheet according to claim 1, which is printed using a dye ink.

9. Printed matter including the ink jet recording sheet according to claim 1, which is printed using a pigment ink.
